(19) United States
(12) Patent Application Publication
(10) Pub. No.: US 2025/0300300 A1
(43) Pub. Date: Sep. 25, 2025

(54) HEAVY OBJECT ACCOMMODATION APPARATUS

(71) Applicant: TOYOTA JIDOSHA KABUSHIKI KAISHA, Aichi-ken (JP)

(72) Inventors: Kenji BABA, Seto-shi (JP); Kenji TAKAHASHI, Toyota-shi (JP)

(21) Appl. No.: 19/056,737

(22) Filed: Feb. 19, 2025

(30) Foreign Application Priority Data
Mar. 21, 2024 (JP) 2024-045597

(51) Int. Cl. H01M 50/267; H01M 50/204; H01M 50/244; H01M 50/264

(52) U.S. Cl. CPC H01M 50/267; H01M 50/244; H01M 50/264; H01M 50/204

(57) ABSTRACT

A heavy object accommodation apparatus includes a frame assembly storing plural heavy objects at multiple levels in a height direction; plural pillar members extending in the height direction; and a pair of attachments extending substantially horizontally between pillar members arranged in a front-rear direction of the frame assembly and the pair of attachments supporting two end portions in a width direction of a heavy object, the width direction being substantially orthogonal to an insertion and removal direction of the heavy object at the apparatus. Each of the attachments includes a longer side portion and a shorter side portion extending in two directions, each of which is substantially orthogonal to the extension direction of the attachment, dimensions of the longer side portion and the shorter side portion in the two directions are different, and the longer and the shorter side portions are fixable to the pillar members and the heavy object.

### CROSS-REFERENCE TO RELATED APPLICATION

This application claims priority under 35 USC 119 from Japanese Patent Application No. 2024-045597 filed Mar. 21, 2024, the disclosure of which is incorporated by reference herein in its entirety.

### BACKGROUND

### Technical Field

The present disclosure relates to a heavy object accommodation apparatus.

### Related Art

Japanese Patent Application Laid-Open (JP-A) No. 2001-015090 discloses a technology relating to a rechargeable battery storage apparatus that includes rechargeable battery storage boxes capable of storing plural rechargeable batteries, and a storage box housing body that is capable of storing a plural number of the rechargeable battery storage boxes. In a specific structure of the rechargeable battery storage apparatus, rail-form shelves are attached to each of a pair of side frames.

The rail-form shelves are formed of steel members, with “L” shapes in cross-section, that span between front side frame members and rear side frame members of the side frames. The shelves are plurally attached, in the same manner, to the rechargeable battery storage boxes that are stored. The shelves support both of width direction side portions of each rechargeable battery storage box from below, along a length direction of the storage box housing body.

### SUMMARY

In JP-A No. 2001-015090, rechargeable batteries that are stored in the rechargeable battery storage apparatus have the same width dimension. However, when the rechargeable battery storage boxes that are being stored are reusable components that have been used for various alternative applications, it becomes necessary for rechargeable battery storage boxes with different width dimensions to be housed in the rechargeable battery storage apparatus.

In this situation, it is necessary to prepare dedicated storage boxes or attachments to fit the width dimensions of the rechargeable batteries (heavy objects), and the number of component increases. Consequently, in conventional technology, storage (accommodation) operations may be complicated and standardization of components may be difficult, leading to higher costs.

In consideration of the circumstances described above, an object of the present disclosure is to provide a heavy object accommodation apparatus that is capable of accommodating heavy objects with different width dimensions.

A heavy object accommodation apparatus according to a first aspect of the present disclosure includes: a frame assembly configured to store plural heavy objects at multiple levels in a height direction of the frame assembly, the frame assembly including an insertion and removal aperture at which the heavy objects are inserted and removed substantially along a horizontal direction; plural pillar members extending in the height direction of the frame assembly; and a pair of attachments, each attachment extending substantially in the horizontal direction between pillar members that are arranged in a front-rear direction of the frame assembly, the pair of attachments being configured to support two end portions in a width direction of a heavy object, and the width direction of a heavy object is substantially orthogonal to the insertion and removal direction of the heavy object. Each of the pair of attachments includes a longer side portion and a shorter side portion, the longer side portion and the shorter side portion extend in two directions, each of which is substantially orthogonal to the extension direction of the attachment, dimensions of the longer side portion and the shorter side portion in the two directions are different from each other, and the dimension of the shorter side portion is shorter than the dimension of the longer side portion, and the longer side portion and the shorter side portion are respectively fixable to the pillar members and to the heavy object.

The heavy object accommodation apparatus according to the first aspect is structured by the frame assembly that houses plural heavy objects at multiple levels in the height direction of the frame assembly. The frame assembly is provided with the insertion and removal aperture at which the heavy objects are inserted and removed substantially along the horizontal direction. The pillar members extend in the height direction of the frame assembly. The pair of attachments extend substantially along the horizontal direction relative to the pillar members that are arranged in the front-rear direction of the frame assembly. Both end portions in the width direction of a heavy object are supported by the pair of attachments.

Each attachment has the longer side portion and the shorter side portion. The longer side portion and shorter side portion extend in the two directions, each direction is substantially orthogonal to the extension direction of the attachment portion, and have different dimensions from each other in the two directions. The shorter side portion is formed with a shorter dimension than the longer side portion. The longer side portion and the shorter side portion are each fixable to the pillar members and to the heavy object.

For example, in a state in which the longer side portion of the attachment is fixed to the pillar members, the shorter side portion of the attachment is fixed to the heavy object, and in a state in which the shorter side portion of the attachment is fixed to the pillar members, the longer side portion of the attachment is fixed to the heavy object.

The longer side portion and the shorter side portion have different dimensions from each other in the two directions, each of which is substantially orthogonal to the extension direction of the attachment. Accordingly, when, for example, the width dimension of a heavy member is small, the heavy object is supported by the longer side portions of the attachments, and when the width dimension of a heavy object is large, the heavy object is supported by the shorter side portions of the attachments.

Thus, in the heavy object accommodation apparatus according to the first aspect, because the attachments in which the dimensions of support portions that support the heavy objects (the longer side portions and the shorter side portions) differ are used, heavy objects with different width dimensions may be supported by attachments of one type.

In other words, a width direction distance between a pair of attachments may be altered. Thus, plural heavy objects with different width dimensions (sizes) may be accommodated in the same heavy object accommodation apparatus with the same attachments.

In a heavy object accommodation apparatus according to a second aspect of the present disclosure, in the heavy object accommodation apparatus according to the first aspect, holes are formed at the longer side portion and the shorter side portion, the holes enabling fixing, via fasteners, of the longer side portion and the shorter side portion to the pillar members and to the heavy object.

In the heavy object accommodation apparatus according to the second aspect, the holes are formed at the longer side portion and shorter side portion of each attachment. The longer side portion and shorter side portion are each fixable to the pillar members and to a heavy object, via fasteners, through the holes.

In a heavy object accommodation apparatus according to a third aspect of the present disclosure, in the heavy object accommodation apparatus according to the second aspect, the holes of at least one of the longer side portion or the shorter side portion are formed as long holes that are formed to be longer in the direction that is substantially orthogonal to the extension direction of the attachment.

In the heavy object accommodation apparatus according to the third aspect, the holes at at least one of the longer side portion or the shorter side portion are formed as long holes that are formed to be longer along the direction of the longer side portion or the shorter side portion that is substantially orthogonal to the extension direction of the attachment. By forming the holes for fixing to a heavy object as the long holes, a position of the fixing via fasteners may be adjustable.

Thus, in the heavy object accommodation apparatus according to the third aspect, the position of the fixing may be adjusted to fit a width direction dimension of a heavy object, and tolerable variations in the width dimensions of the heavy objects may be further increased.

In a heavy object accommodation apparatus according to a fourth aspect of the present disclosure, in the heavy object accommodation apparatus according to the second aspect, the holes of at least one of the longer side portion or the shorter side portion are formed as plural round holes formed along the direction that is substantially orthogonal to the extension direction of the attachment.

In the heavy object accommodation apparatus according to the fourth aspect, the holes at at least one of the longer side portion or the shorter side portion are formed as plural round holes formed along the direction of the longer side portion or shorter side portion that is substantially orthogonal to the extension direction of the attachment. By forming the holes for fixing to a heavy object as plural numbers of the round holes, a position of the fixing, via fasteners, may be adjustable.

Thus, in the heavy object accommodation apparatus according to the fourth aspect, the position of the fixing may be adjusted to fit a width direction dimension of a heavy object. When width dimension variations of heavy objects are limited, the longer side portion or shorter side portion may be more securely fixed to a heavy object by fixing fasteners to the heavy object through the round holes.

In a heavy object accommodation apparatus according to a fifth aspect of the present disclosure, in the heavy object accommodation apparatus according to the first aspect, a shape of the attachment as seen in the extension direction forms a substantial “L” shape.

In the heavy object accommodation apparatus according to the fifth aspect, the shape of the attachment as seen in the extension direction is formed in the substantial “L” shape, with the attachment including the longer side portion and the shorter side portion whose dimensions in length directions substantially orthogonal to the extension direction are different from one another.

In a heavy object accommodation apparatus according to a sixth aspect of the present disclosure, in the heavy object accommodation apparatus according to the first aspect, plural first fixing holes are formed at each pillar member, the plural first fixing holes being formed along the height direction, and the first fixing holes enabling fixing, via fasteners, of the longer side portion or the shorter side portion to the pillar member.

In the heavy object accommodation apparatus according to the sixth aspect, plural number of the first fixing holes are formed along the height direction at each pillar member, and the longer side portion or shorter side portion of the attachment is fixable to the pillar members via the fasteners. Thus, plural attachments may be fixed along the height direction at the pillar members. Therefore, plural heavy objects may be stored at multiple levels in the heavy object accommodation device, and heavy objects with different heights may be accommodated in the heavy object accommodation apparatus.

In a heavy object accommodation apparatus according to a seventh aspect of the present disclosure, in the heavy object accommodation apparatus according to the first aspect, a flange projecting to an outer side in the width direction of the heavy object is formed at at least one of two ends in the width direction of the heavy object, the longer side portion or the shorter side portion being configured to abut and to be fixed to a lower surface of the flange.

In the heavy object accommodation apparatus according to the seventh aspect, the flange is provided at one or both ends in the width direction of the heavy object. Each flange is formed to project to the outer side in the width direction of the heavy object. The longer side portion or shorter side portion of the attachment may be abutted and fixed to the lower surface of the flange.

When the heavy object is a rechargeable battery for a vehicle, flanges may be formed at outer sides in the width direction of the rechargeable battery, and the rechargeable battery may be fastened to rockers via the flanges. In this structure, fixed holes for fastening are formed at the flanges. These fixed holes may be used for fixing the flanges to the attachments.

In a heavy object accommodation apparatus according to an eighth aspect of the present disclosure, in the heavy object accommodation apparatus according to the seventh aspect, plural holes are formed at the longer side portion and the shorter side portion, the plural holes being formed along the extension direction of the attachment, and the plural holes enabling fixing, via fasteners, of the longer side portion and the shorter side portion to the pillar members and to the heavy object, and plural second fixing holes are formed at the flange along the insertion and removal direction of the heavy object, positions of the plural holes corresponding with the second fixing holes.

In the heavy object accommodation apparatus according to the eighth aspect, the second fixing holes are formed at the flange in plural number along the insertion and removal direction of the heavy object. The positions of the plural holes formed at the longer side portion or the shorter side portion along the extension direction of the attachment correspond with the second fixing holes.

The second fixing holes formed at the flange of the heavy object may be put into correspondence with the holes formed at the longer side portion or shorter side portion of the attachment, and the heavy object may be fixed to the attachment via the fasteners.

In a heavy object accommodation apparatus according to a ninth aspect of the present disclosure, in the heavy object accommodation apparatus according to the first aspect, the heavy objects include a rechargeable battery.

In the heavy object accommodation apparatus according to the ninth aspect, a heavy object is a rechargeable battery and the rechargeable battery is accommodated in the heavy object accommodation apparatus. In the present disclosure, because heavy objects with different width dimensions may be accommodated, it is possible to accommodate, for example, reusable rechargeable batteries that are used for alternative purposes other than as rechargeable batteries for vehicles in the same heavy object accommodation apparatus.

As described above, the heavy object accommodation apparatus according to the present disclosure may accommodate heavy objects with different width dimensions.

### BRIEF DESCRIPTION OF THE DRAWINGS

FIG. 1 is a schematic perspective view showing a battery pack accommodation apparatus according to a present exemplary embodiment;

FIG. 2 is a schematic elevation view showing a state in which plural battery packs are accommodated in the battery pack accommodation apparatus according to the present exemplary embodiment;

FIG. 3A is a perspective view showing an attachment provided at the battery pack accommodation apparatus according to the present exemplary embodiment;

FIG. 3B is a sectional view cut along line A-A shown in FIG. 3A; and

FIG. 4 is a schematic perspective view showing a battery pack to be accommodated in the battery pack accommodation apparatus according to the present exemplary embodiment.

### DETAILED DESCRIPTION

A heavy object accommodation apparatus according to an exemplary embodiment of the present disclosure is described using the attached drawings.

### —Structure of the Heavy Object Accommodation Apparatus—

First, structures of the heavy object accommodation apparatus according to the exemplary embodiment of the present disclosure are described.

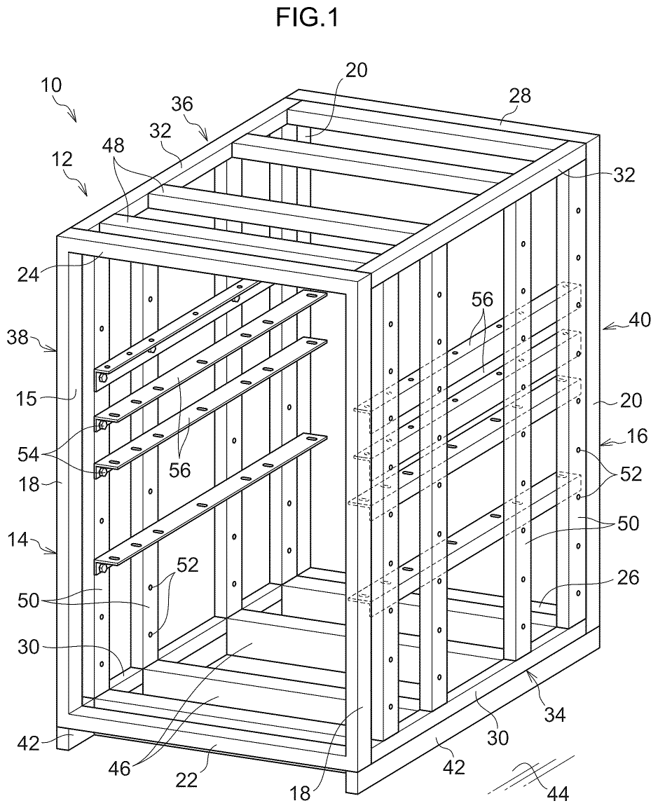

FIG. 1 shows a battery pack accommodation apparatus 10 that serves as the heavy object accommodation apparatus according to the present exemplary embodiment. The battery pack accommodation apparatus 10 is formed in a rectangular box shape structured by a frame assembly 12. As an example in the present exemplary embodiment, the battery pack accommodation apparatus 10 includes a front frame portion 14 and a rear frame portion 16. The front frame portion 14 structures a front end portion of the battery pack accommodation apparatus 10 and the rear frame portion 16 structures a rear end portion of the battery pack accommodation apparatus 10.

The front frame portion 14 includes a pair of pillars 18 along a height direction of the battery pack accommodation apparatus 10 (and the front frame portion 14). A lower beam member 22 spans between lower ends of the pair of pillars 18, and an upper beam member 24 spans between upper ends of the pair of pillars 18. In other words, the front frame portion 14 is structured by the pair of pillars 18, the lower beam member 22 and the upper beam member 24.

The rear frame portion 16 includes a pair of pillars 20 along the height direction of the battery pack accommodation apparatus 10 (and the rear frame portion 16). A lower beam member 26 spans between lower ends of the pair of pillars 20, and an upper beam member 28 spans between upper ends of the pair of pillars 20. In other words, the rear frame portion 16 is structured by the pair of pillar s 20, the lower beam member 26 and the upper beam member 28. These beam members are depicted with rectangular solid shapes but, for example, U steel, H steel or the like can be used.

A pair of lower beam members 30 span between, respectively, lower ends of the pair of pillars 18 structuring the front frame portion 14 and lower ends of the pair of pillars 20 structuring the rear frame portion 16. A pair of upper beam members 32 span between, respectively, upper ends of the pair of pillars 18 and upper ends of the pair of pillars 20.

A lower frame portion 34 is structured by the lower beam member 22 of the front frame portion 14, the lower beam member 26 of the rear frame portion 16 and the pair of lower beam members 30. An upper frame portion 36 is structured by the upper beam member 24 of the front frame portion 14, the upper beam member 28 of the rear frame portion 16 and the pair of upper beam members 32. A pair of side frame portions 38 and 40 are structured by the pillars 18 of the front frame portion 14, the pillars 20 of the rear frame portion 16, the lower beam members 30 and the upper beam members 32.

Battery packs (rechargeable batteries) 11 can be accommodated in the frame assembly 12 that is structured in this manner of the front frame portion 14, the rear frame portion 16, the lower frame portion 34, the upper frame portion 36 and the pair of side frame portions 38 and 40. An aperture 15 at the front frame portion 14 serves as an insertion and removal aperture at which the battery packs 11 can be inserted and removed. Accordingly, this aperture is referred to as the insertion and removal aperture 15 in the descriptions below.

The lower frame portion 34 constitutes a base of the battery pack accommodation apparatus 10. For example, a pair of leg bodies 42 depend from a lower face of the lower frame portion 34. The leg bodies 42 respectively extend in a front-rear direction of the battery pack accommodation apparatus 10 at both end portions in a width direction of the battery pack accommodation apparatus 10. The leg bodies 42 are depicted with rectangular solid shapes but, for example, steel members of H steel or the like can be used and may be fixed to a placement surface 44. Plural beam members 46 that span between the pair of lower beam members 30 are provided inside the lower frame portion 34 and may be abutted against the placement surface 44.

Plural beam members 48 that span between the pair of upper beam members 32 are provided inside the upper frame portion 36. Inside the pair of side frame portions 38 and 40, respectively plural pillars 50 that span between the corresponding upper beam member 32 and lower beam member 30 are provided. Fixing holes (first fixing holes) 52 are provided at the pillars 50 in plural numbers along the height direction. Fasteners 54, such as bolts or the like, can be fixed to the pillars 50 via the fixing holes 52.

In the present exemplary embodiment, attachments 56 span (extend) substantially in the horizontal direction between the pillars 18 and 20, and the battery packs 11 are supported by the attachments 56.

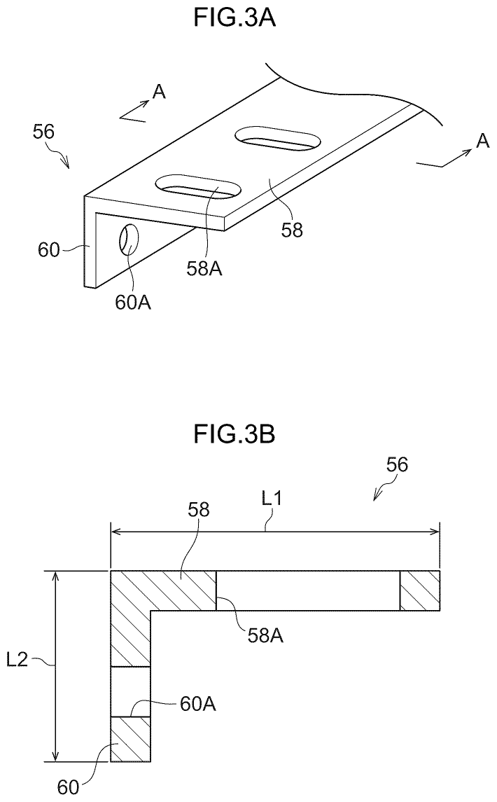

As shown in FIG. 3A and FIG. 3B, each attachment 56 is formed in a substantial “L” shape of, for example, steel plate, and is specified with a length capable of extending along a length direction of the battery pack accommodation apparatus 10.

Each attachment 56 includes a longer side portion 58 and a shorter side portion 60 that are substantially orthogonal to the extension direction of the attachments 56. Length dimensions L1 of the longer side portion 58 and L2 of the shorter side portion 60 are different from one another (L1>L2). The longer side portion 58 and the shorter side portion 60 are each fixable to the pillars 18, 20 and 50 and to the battery packs 11.

Long holes 58A are formed at the longer side portion 58. Each long hole 58A is longer in a length direction of the longer side portion 58. The longer side portion 58 can be fixed to the pillars 18, 20 and 50 or to the battery pack 11 via the fasteners 54 (see FIG. 1), which are inserted through the interiors of the long holes 58A.

Round holes 60A are formed at the shorter side portion 60. The shorter side portion 60 can be fixed to the battery pack 11 or to the pillars 18, 20 and 50 via the fasteners 54 (see FIG. 1), which are inserted into the interior of the round holes 60A. The long holes 58A and round holes 60A are provided on the same lines along a width direction of the attachment 56, and are provided in plural numbers along the extension direction of the attachment 56 (described below).

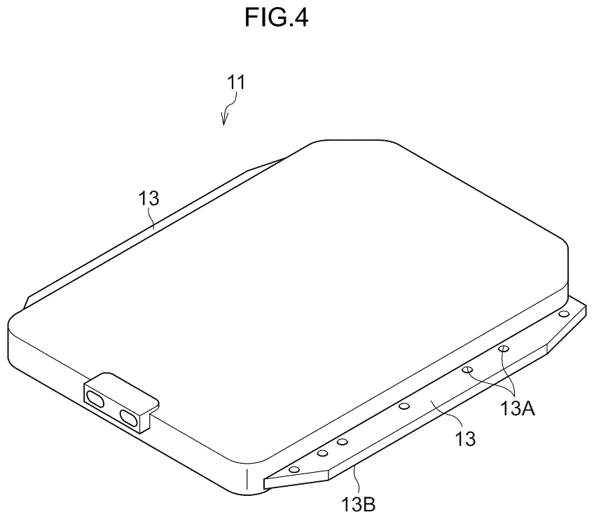

As shown in FIG. 4, each battery pack 11 is formed in a substantially rectangular plate shape in plan view, with flanges 13 projecting to outer sides from both end portions in a width direction of the battery pack 11. Therefore, the battery pack 11 is in a state in which, in a front view, lower end portions and upper end portions of the two ends in the width direction are cut away in substantial “L” shapes. In other words, steps are provided at a top face and a bottom face of the battery pack 11.

Although not shown in the drawings, the battery pack 11 can be attached to a pair of rockers via the flanges 13. The rockers respectively extend in a vehicle front-rear direction at both end portions in a width direction of a floor panel of a vehicle. Accordingly, a plural number of fixing holes for attachment (second fixing holes) 13A are formed at each flange 13.

As described above, the long holes 58A and round holes 60A of each attachment 56 are plurally provided along the extension direction of the attachment 56, and are formed to match a pitch of the fixing holes 13A formed at the flange 13.

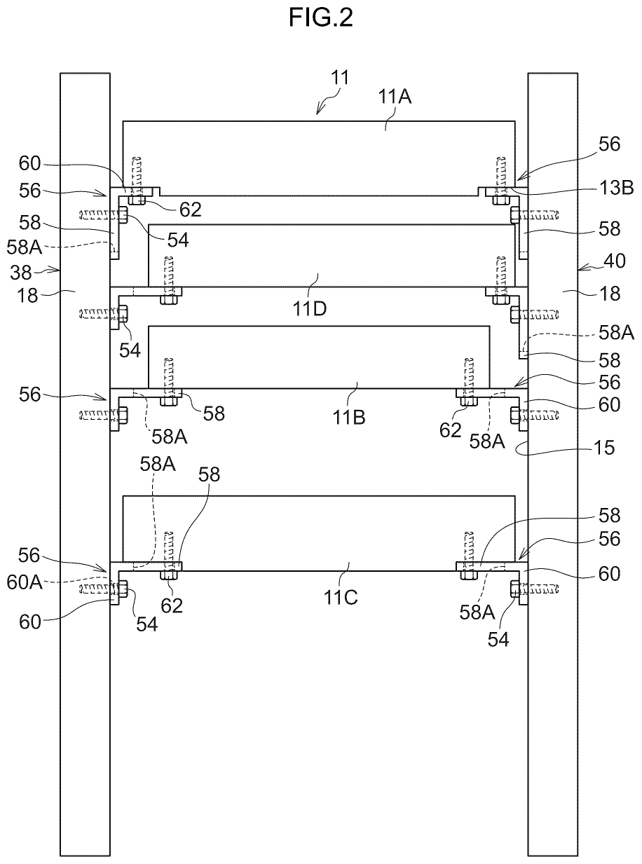

Therefore, in a state in which lower surfaces 13B of the flanges 13 of the battery pack 11 are abutted against the attachments 56, the fixing holes 13A of the flanges 13 substantially coincide with positions of the long holes 58A or round holes 60A of the attachments 56, and fasteners 62 (see FIG. 2) can be inserted in the holes. The battery pack 11 is fixed to the attachments 56 via the fasteners 62. Note that the battery packs 11 are not necessarily limited to battery packs for vehicles, and that the shapes of the battery packs 11 as shown in FIG. 2 are simplified.

### —Operation and Effects of the Heavy Object Accommodation Apparatus—

Operation and effects of the heavy object accommodation apparatus according to the exemplary embodiment of the present disclosure are described.

In the present exemplary embodiment as illustrated in FIG. 1 and FIG. 2, the battery pack accommodation apparatus 10 is constituted by the frame assembly 12 that accommodates plural battery packs 11 at multiple levels in the height direction, and the insertion and removal aperture 15 at which the battery packs 11 are inserted and removed substantially along the horizontal direction is provided at the frame assembly 12.

The pillars 18 and 20 that extend in the height direction of the frame assembly 12 are provided at the frame assembly 12. Pairs of the attachments 56 extend in substantially horizontal directions between the plural pillars 18, 20 and 50, and both end portions in the width direction of each battery pack 11 are supported by a corresponding pair of the attachments 56.

As shown in FIG. 3A and FIG. 3B, each attachment 56 includes the longer side portion 58 and shorter side portion 60 that are formed to be substantially orthogonal to the extension direction, and the length dimensions of the longer side portion 58 and shorter side portion 60 are different from one another. The longer side portion 58 and the shorter side portion 60 are each fixable to the pillars 18, 20 and 50 and to the battery pack 11.

That is, as shown in FIG. 1 and FIG. 2, in a state in which a longer side portion 58 of an attachment 56 is fixed to the pillars 18, 20 and 50, a shorter side portion 60 of the attachment 56 is fixed to a battery pack 11A. Alternatively, in a state in which the shorter side portion 60 of the attachment 56 is fixed to the pillars 18, 20 and 50, the longer side portion 58 of the attachment 56 is fixed to a corresponding battery pack 11B or 11C.

Alternately, a shorter side portion 60 of an attachment 56 is fixed to the pillars 18, 20 and 50 at the side frame portion 38, and a longer side portion 58 of an attachment 56 is fixed to the pillars 18, 20 and 50 at the side frame portion 40. In this state, a longer side portion 58 of the attachment 56 disposed at the side frame portion 38 and a shorter side portion 60 of the attachment 56 disposed at the side frame portion 40 are respectively fixed to a battery pack 11D.

In the present exemplary embodiment, dimensions of a longer side portion 58 and a shorter side portion 60 of each attachment 56 supporting the battery packs 11 are different from one another. Therefore, for example, when a width dimension is small as with a battery pack 11B, the battery pack 11B is supported by longer side portions 58 of attachments 56, and when a width dimension is large as with a battery pack 11A, the battery pack 11A is supported by shorter side portions 60 of attachments 56.

Thus, in the present exemplary embodiment, because the attachments 56 are used whose support portions for supporting the battery packs 11 (the longer side portions 58 and the shorter side portions 60) have different dimensions, the battery packs 11A, 11B and so forth with different width dimensions may be supported by the attachments 56 of one type.

That is, in the present exemplary embodiment, a width direction distance between a pair of the attachments 56 may be altered, and the plural battery packs 11A, 11B and the like with different width dimensions (sizes) may be accommodated in the same battery pack accommodation apparatus 10 with the same attachments 56. In other words, in the present exemplary embodiment there is no need to prepare different battery pack accommodation apparatus 10 for each size of battery packs 11.

In the present exemplary embodiment, each attachment 56 includes a longer side portion 58 and a shorter side portion 60, and long holes 58A are formed to be long in a length direction of the longer side portion 58. The longer side portion 58 may be fixed to the pillars 18, 20 and 50 or to the battery pack 11 by the long holes 58A, via the fasteners 54 or 62.

Thus, in the present exemplary embodiment, because the long holes 58A are formed at the longer side portion 58, as with the battery packs 11B and 11C, fixing positions to each battery pack 11B or 11C may be adjusted to fit a width direction dimension of each battery pack. Therefore, in the battery pack accommodation apparatus 10 according to the present exemplary embodiment, tolerable variations in the width dimensions of the battery packs 11A, 11B, 11C and 11D may be increased further.

In the present exemplary embodiment, the round holes 60A are formed at a shorter side portion 60, and the shorter side portion 60 may be more securely fixed to the pillars 18, 20 and 50 or to the battery pack 11A by fixing of the shorter side portion 60 to the pillar members 18, 20 and 50 or battery pack 11A via the fasteners 54 or 62 through the round holes 60A.

In the present exemplary embodiment, plural fixing holes 52 are provided along the height direction at pillars 50, and longer side portions 58 or shorter side portions 60 of attachments 56 may be fixed to the pillars 50 via the fasteners 54.

Thus, in the present exemplary embodiment, the attachments 56 may be fixed in plural numbers along the height direction of the pillars 50, and therefore the plural battery packs 11 may be stored in the battery pack accommodation apparatus 10 at multiple levels in the height direction. In addition, heavy objects with different heights may be accommodated.

In the present exemplary embodiment, respective pairs of flanges 13 can be formed at the battery packs 11 and project to the outer sides from both ends in the width direction of each battery pack 11. A longer side portion 58 or shorter side portion 60 of each attachment 56 may be abutted and fixed to a lower surface 13B of corresponding flange 13.

When the battery pack 11 is for a vehicle, the flanges 13 are formed at the width direction outer sides of the battery pack 11, and the battery pack 11 is to be fastened to rockers, which are not shown in the drawings, via the flanges 13. For this purpose, the fixing holes 13A for fastening are formed at the flanges 13. In the present exemplary embodiment, the fixing holes 13A may be used for fixing the flanges 13 to the attachments 56.

In the present exemplary embodiment, plural fixing holes 13A are formed at each flange 13 along the insertion and removal direction of the battery pack 11, and long holes 58A and round holes 60A are formed in plural numbers along the extension direction of each attachment 56 to correspond with the fixing holes 13A.

In the present exemplary embodiment, fixing holes 13A formed at each flange 13 of a battery pack 11 may be put into correspondence with long holes 58A formed at a longer side portion 58 of an attachment 56 or round holes 60A formed at a shorter side portion 60, and the battery pack 11 may be fixed to the attachment 56 via the fasteners 54.

In the present exemplary embodiment, the battery packs 11 are rechargeable batteries, and plural rechargeable batteries are accommodated in the battery pack accommodation apparatus 10. Because rechargeable batteries with different width dimensions may be accommodated, even, for example, reusable rechargeable batteries that are used for alternative purposes other than as rechargeable batteries for vehicles may be accommodated in the battery pack accommodation apparatus 10.

### Supplementary Descriptions of the Exemplary Embodiment

In the exemplary embodiment described above, the battery pack accommodation apparatus 10 in which the battery packs 11 are accommodated as illustrated in FIG. 2 is described as the heavy object accommodation apparatus. However, the heavy object accommodation apparatus needs to accommodate heavy objects, and the heavy objects are not limited to battery packs.

In the exemplary embodiment described above, as shown in FIG. 1, the insertion and removal aperture 15 is provided at the side of the battery pack accommodation apparatus 10 at which the front frame portion 14 is disposed, and the battery packs 11 may be inserted and removed through the insertion and removal aperture 15. However, the battery packs 11 may also be inserted and removed at the rear frame portion 16.

In the exemplary embodiment described above, the battery pack accommodation apparatus 10 is structured by the frame assembly 12 including the front frame portion 14, the rear frame portion 16, the lower frame portion 34, the upper frame portion 36 and the pair of side frame portions 38 and 40, and each frame portion is in a state of communication with the exterior. Clearly, wall portions that separate the frame portions from the exterior may be provided at the frame portions.

In the exemplary embodiment described above, as shown in FIG. 1 and FIG. 2, each attachment 56 is formed in a substantial “L” shape structured by the longer side portion 58 and the shorter side portion 60, but this is not limiting. For example, although not shown in the drawings, ribs that reinforce the longer side portion 58 and the shorter side portion 60 may be provided at an inner face side of the attachment 56.

In the exemplary embodiment described above, the long holes 58A are formed along the length direction of the longer side portion 58 of the attachment 56. However, round holes may be formed along the length direction of the longer side portion 58. This is favorable in regard to stiffness of the longer side portion 58 if width dimension variations of the battery packs 11 are limited to some extent.

In the exemplary embodiment described above, the round holes 60A are formed at the shorter side portion 60 of the attachment 56. However, long holes may be formed along the length direction of the shorter side portion 60, or plural round holes may be formed along the length direction of the shorter side portion 60.

In the exemplary embodiment described above, the flanges 13 respectively project from the both ends in the width direction of the battery pack 11, and the flanges 13 are fixed to the respective attachments 56, but this is not limiting.

For example, a shape is possible in which a flange 13 projects only from one end in the width direction of the battery pack 11. It is also possible that no flange 13 is formed, depending on the battery pack 11 (for example, the battery pack 11B or 11D). In particular, when no flange 13 is formed at a stationary-type rechargeable battery or the like, width direction end portions of this battery pack 11 are fixed to the attachments 56.

Here above, an exemplary embodiment of the present disclosure has been described, but the present disclosure is not limited by this exemplary embodiment. The exemplary embodiment and various variant examples may be used in suitable combinations, and it will be clear that numerous modes may be embodied within a technical scope of the present disclosure.

### ADDITIONAL REMARKS

The structures described below may be suitably combined to serve as the vehicle framework member according to the present disclosure.

### —Structure 1—

A heavy object accommodation apparatus includes: a frame assembly that stores plural heavy objects at multiple levels in a height direction, the frame assembly including an insertion and removal aperture at which the heavy objects are inserted and removed substantially along a horizontal direction; plural pillar members extending in the height direction of the frame assembly, the pillar members structuring at least corner portions of the frame assembly; a pair of attachments, each attachment extending substantially in the horizontal direction between the plural pillar members that are arranged in a front-rear direction of the frame assembly, and the pair of attachments supporting end portions in a width direction of one of the heavy objects, the width direction of the heavy object is substantially orthogonal to the insertion and removal direction of the heavy object. Each of the pair of attachments includes a longer side portion and a shorter side portion, the longer side portion and the shorter side portion extend in two directions that each direction is substantially orthogonal to the extension direction of the attachment, dimensions of the longer side portion and the shorter side portion in the two directions are different from one another, the dimension of the shorter side portion is shorter than the dimension of the longer side portion, and the longer side portion and the shorter side portion are each fixable to the pillar members and to the heavy object.

### —Structure 2—

Holes are provided at the longer side portion and the shorter side portion, the holes enabling fixing via fasteners of the longer side portion and the shorter side portion to the pillar members and to the heavy object.

### —Structure 3—

Holes of at least one of the longer side portion and the shorter side portion are formed as long holes that is formed to be longer in the direction that is substantially orthogonal to the extension direction of the attachment.

### —Structure 4—

Holes of at least one of the longer side portion and the shorter side portion are formed as plural round holes formed along the direction that is substantially orthogonal to the extension direction of the attachment.

### —Structure 5—

A shape of the attachment as seen in the extension direction forms a substantial “L” shape.

### —Structure 6—

Plural first fixing holes are provided at each pillar member, the plural first fixing holes being formed along the height direction, and the first fixing holes enabling fixing via fasteners of the longer side portion or the shorter side portion to the pillar member.
Structure 7—

A flange projecting to an outer side in the width direction of the heavy object is formed at at least one of the two ends in the width direction of the heavy object, the longer side portion or the shorter side portion being configured to abut and be fixed to a lower surface of the flange.

### —Structure 8—

Holes are provided at the longer side portion and the shorter side portion, the holes being formed along the extension direction of the attachment, and the holes enabling fixing via fasteners of the longer side portion and the shorter side portion to the pillar members and to the heavy object, and plural second fixing holes are formed at the flange along the insertion and removal direction of the heavy object, positions of the holes corresponding with the second fixing holes.

### —Structure 9—

The heavy objects include a rechargeable battery.

What is claimed is:

1. A heavy object accommodation apparatus comprising:
a frame assembly configured to store a plurality of heavy objects at multiple levels in a height direction of the frame assembly, the frame assembly including an insertion and removal aperture at which the heavy objects are inserted and removed substantially along a horizontal direction;
a plurality of pillar members extending in the height direction of the frame assembly; and
a pair of attachments, each attachment extending substantially in a horizontal direction between pillar members that are arranged in a front-rear direction of the frame assembly, the pair of attachments being configured to support two end portions in a width direction of a heavy object, and the width direction of a heavy object being substantially orthogonal to the insertion and removal direction of the heavy object, wherein:
each of the pair of attachments includes a longer side portion and a shorter side portion,
the longer side portion and the shorter side portion extend in two directions, each of which is substantially orthogonal to the extension direction of the attachment, dimensions of the longer side portion and the shorter side portion in the two directions are different from each other, and the dimension of the shorter side portion is shorter than the dimension of the longer side portion, and
the longer side portion and the shorter side portion are respectively fixable to the pillar members and to the heavy object.

2. The heavy object accommodation apparatus according to claim 1, wherein holes are formed at the longer side portion and the shorter side portion, the holes enabling fixing, via fasteners, of the longer side portion and the shorter side portion to the pillar members and to the heavy object.

3. The heavy object accommodation apparatus according to claim 2, wherein the holes of at least one of the longer side portion or the shorter side portion are formed as long holes that are formed to be longer in the direction that is substantially orthogonal to the extension direction of the attachment.

4. The heavy object accommodation apparatus according to claim 2, wherein the holes of at least one of the longer side portion or the shorter side portion are formed as a plurality of round holes formed along the direction that is substantially orthogonal to the extension direction of the attachment.

5. The heavy object accommodation apparatus according to claim 1, wherein a shape of the attachment as seen in the extension direction of the attachment forms a substantial “L” shape.

6. The heavy object accommodation apparatus according to claim 1, wherein a plurality of first fixing holes are formed at each pillar member, the plurality of first fixing holes being formed along the height direction, and the first fixing holes enabling fixing, via fasteners, of the longer side portion or the shorter side portion to the pillar member.

7. The heavy object accommodation apparatus according to claim 1, wherein a flange projecting to an outer side in the width direction of the heavy object is formed at at least one of two ends in the width direction of the heavy object, the longer side portion or the shorter side portion being configured to abut and to be fixed to a lower surface of the flange.

8. The heavy object accommodation apparatus according to claim 7, wherein:
a plurality of holes are formed at the longer side portion and the shorter side portion, the plurality of holes being formed along the extension direction of the attachment, and the plurality of holes enabling fixing, via fasteners, of the longer side portion and the shorter side portion to the pillar members and to the heavy object, and
a plurality of second fixing holes are formed at the flange along the insertion and removal direction of the heavy object, positions of the plurality of holes corresponding with the plurality of second fixing holes.

9. The heavy object accommodation apparatus according to claim 1, wherein the heavy objects include a rechargeable battery.
